(19) United States
(12) Patent Application Publication
(10) Pub. No.: US 2002/0196237 A1
(43) Pub. Date: Dec. 26, 2002

(54) Touch pad that confirms its security

(76) Inventors: Llavanya X. Fernando, San Jose, CA (US); G.F.R. Sulak Soysa, San Jose, CA (US); Robert W. Wilmot, Los Altos, CA (US)

Correspondence Address: FLEHR HOHBACH TEST ALBRITTON & HERBERT LLP, Four Embarcadero Center, Suite 3400, San Francisco, CA, 94111-4187, US

(21) Appl. No.: 09/887,150

(22) Filed: Jun. 21, 2001

(51) Int. Cl. G09G 5/00

(52) U.S. Cl. 345/173

(57) ABSTRACT

Apparatus and methods for secure data entry. The apparatus includes a device for entering data, a display for displaying information confirming the security of the data-entry apparatus and an encryption circuit, communicatively coupled to the data-entry device and the display. The device for entering data may be a touch pad. The first and second displays are physically separate and are under the control of respective controllers, in turn communicatively coupled to and under the control of the encryption circuit. The displayed information may be an icon. The data-entry apparatus refrains from displaying information asserting the device's ability to securely receive data. The data-entry device then prepares to receive encrypted data received. It then displays information asserting the data-entry device's ability to securely receive the data.

### RELATED APPLICATIONS

This application claims the benefit of the following application:

U.S. patent application Ser. No. 60/252,800, entitled, “A Touch Pad that Confirms its Security,” filed Nov. 21, 2000, naming G. F. R. Sulak Soysa et al. as inventors, with Attorney Docket No. A-70049/MAK/LM and commonly assigned to @pos.com, Inc. of San Jose, Calif.

U.S. patent application Ser. No. 60/252,800 is incorporated by reference herein.

This application is related to:

U.S. patent application Ser. No. 09/588,109, entitled, “Secure, Encrypting PIN Pad,” filed May 31, 2000, naming James C. Lungaro, Susan W. Tso, Llavanya Fernando and Simon Lee as inventors, with Attorney Docket No. A-68938/MAK/LM and commonly assigned to @pos.com, Inc. of San Jose, Calif.

U.S. patent application Ser. No. 09/588,109 is incorporated by reference herein.

This invention relates to the touch pads, display, touchscreens and secure data entry. More particularly, the invention relates to confirming to the user the security of data to be entered on a touch pad during, for example, a consumer transaction.

### BACKGROUND

All of the credit- and debit-card companies are experiencing high levels of fraud, including Visa International, MasterCard International, American Express Company and Discover Bank. The ease of circumventing the hardware or software security of a PIN entry device has contributed to this fraud over the last ten years. Visa and MasterCard project an increase of annual losses on credit and debit cards of $843.2 million in 2001 to $2.13 billion by 2010. Accordingly, the payment companies are requiring stricter security—both physical and logical—for payment devices.

Older conventional devices for debit transactions are physically and logically secure. Tamper-detect switches inside a device including a casing erase valuable information if the casing is broken. Security grids and ruggedized security shrouds prevented drilling into the device. Logical security measures manage cryptographic keys (to encrypt PIN numbers) and transaction data within the device. Additionally, the logical security ensures message authentication coding during message transit.

The advent of reliable and less expensive LCD and touchscreen technologies brought the corresponding evolution of newer payment devices that incorporated the technologies—payment terminals, personal digital assistants (PDAs), and Internet appliances, for example. These newer devices enable customers to interact with the devices during transactions. However, the transactions from such devices are not as secure (physically or logically) as those from the older devices.

One such newer device is the iPOS TC transaction terminal available from the Assignee of the instant invention. The iPOS TC is a web-enabled payment device for secure debit and credit transactions. Dual channels securely simultaneously transmit electronic transaction and signature data on one channel and advertising and promotional media from the World-Wide Web (the web), on the other.

These newer devices are more programmable and have more functionality than the older conventional devices. Because of their status on the web, however, they are increasingly susceptible to attacks by hackers. These malfeasants may re-program the device, for example, to make information normally encrypted appear in the clear or to display rogue keypads, thus compromising security.

Accordingly, there is a need in the art for a payment device that protects against a user entering information on a rogue keypad, thus reducing the chances of fraudulent activity from the device.

These and other goals of the invention will be readily apparent to one of ordinary skill in the art on reading the background above and the description below.

### BRIEF DESCRIPTION OF THE DRAWINGS

FIGS. 1 and 2 illustrate the touch pad of a payment device, according to one embodiment of the invention.

FIG. 3 illustrates the circuitry of a payment device, according to one embodiment of the invention.

(The drawings are not to scale.)

### DESCRIPTION OF THE INVENTION

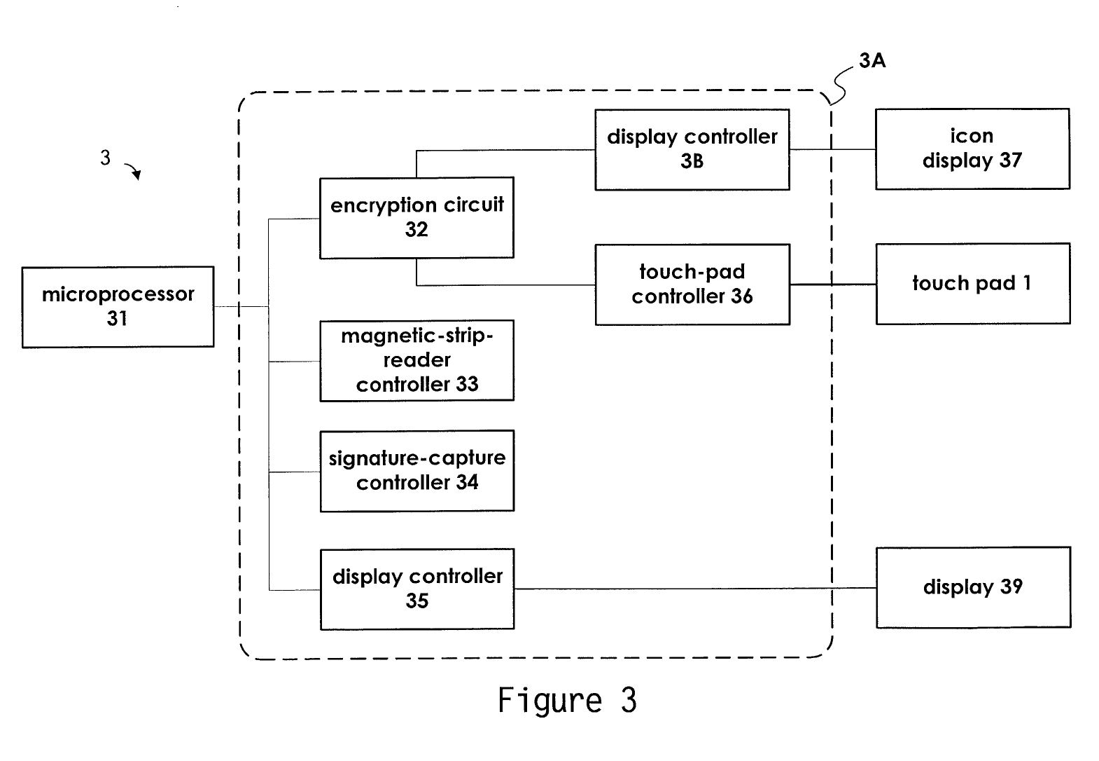

FIG. 3 illustrates the circuitry 3 of a payment device according to one embodiment of the invention. The circuitry 3 includes a microprocessor 31, an encryption circuit 32, a MSR circuit 33, a signature-capture circuit 34, first and second display controllers 35, 3B, a touch-pad controller 36, a security-icon display 37, a touch pad 1 and a (general) display 39.

The microprocessor 31 communicatively couples to the encryption circuit 32, the MSR circuit 33, the signature-capture circuit 34 and the display controller 35. The encryption circuit 32 communicatively couples with the display controller 3B that itself communicatively couples with the security display 37. The display controller 35 and the (general) display 39 communicatively couple. The encryption circuit 32 communicatively couples with the touch pad controller 36 that itself communicatively couples with the touch pad 1.

U.S. patent application Ser. No. 09/588,109 describes an encryption circuit 32. That encryption circuit 32 may include a CPU, a memory, a touch-pad interface and a POS-system interface (all not shown here). The memory of the encryption circuit 32 may be programmed to perform the invention as described herein, including receiving, converting and encrypting input from the controller 36. Alternatively, the encryption circuit 32 may include an application-specific integrated circuit (ASIC) or other hardware for performing encryption.

The controllers 32, 33, 34, 35 and 36 are preferably within a single chip 3A (which also has a microprocessor as described above). Alternatively, a chip with an embedded microprocessor and other components (such as a digital-signal-processor block) to implement the various algorithms described herein) may be used instead. The Intel Xscale™ Microarchitecture from Intel Corp. (Santa Clara, Calif.) is an example. (See http://developer.intel.com/design/intelxscale/index.htm.)

The circuit 3A may be embedded using the chip-on-glass process known in the art. The circuit 3A may be one or more ASICs.

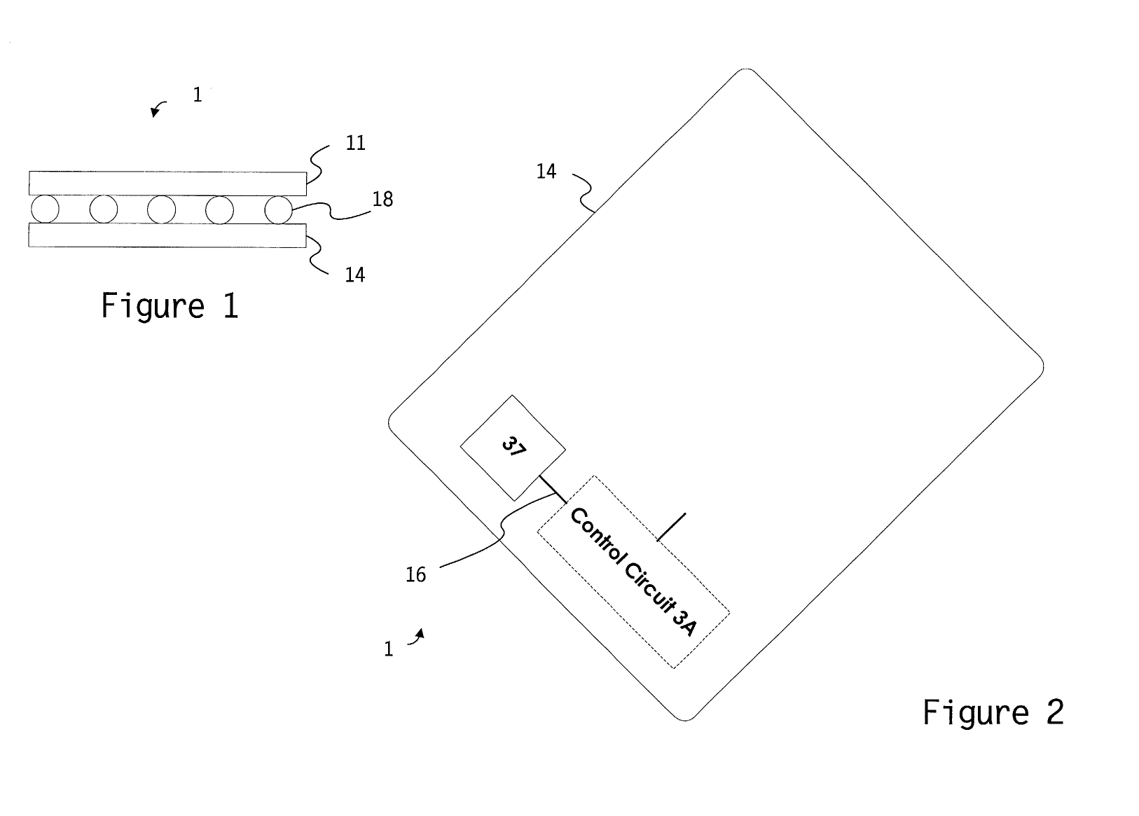

FIGS. 1 and 2 illustrate the touch pad 1 of a payment device, according to one embodiment of the invention. The touch pad 1 may include a conductive flexible membrane 11, insulated dots 18 and a rigid backer 14. Between the membrane 11 and the rigid substrate 14, the touch pad 1 may include the display 37, control circuitry 3A and a communications link 16.

The display 37 may be one or more LCDs, one or more LEDs of the art or both.

The link 16 communicatively couples the control circuit 3A and the display 37.

In a process herein termed “keypad obfuscation,” Lungaro et al., U.S. patent application Ser. No. 09/588,109, “A Secure, Encrypting PIN Pad,” encrypts PIN pad data before the data travels beyond the PIN pad. The touch pad 1 described herein may apply keypad obfuscation to data entered on it. Data such as PIN and account numbers may be obfuscated, as may data for transmission to payment processors, keys for password verification and program validation, etc. The encryption circuit 32 may provide this service.

The signature-capture circuit 34 enables the device 1 to capture and validate signatures entered via the touch pad 1.

For the benefit of a customer transacting business on a device incorporating the touch pad 1, the encryption circuit 32 may direct the display controller 3B to display an icon or other predetermined indicator visible to the customer on the display 37. The encryption circuit 32 may do so when it has determined that data to be entered on the touch pad 1 will be secure. The visible indicator ensures the user that the device 1 is indeed secure for data entry.

Consider the use of an embodiment of the invention in a personal digital assistant (PDA). The touchpad would be used primarily for data entry (e.g., as a graffiti pad). In such cases, the encryption functions are not used. However, when the user wishes to perform a financial transaction, for example, the security functions are activated.

A typical transaction may progress as follows: When the user initiates a transaction, the microprocessor 31 initiates the display of, say, a virtual PIN pad on the display 39 by invoking a software routine, say, the Virtual PIN Pad routine (VPPR). Now the VPPR cues the security circuit 32 to initialize the security functions. Among the initializations is the display of the secure icon on the display 37.

The VPPR cue to the security circuit 32 may include a binary code. If the security circuit 32 does not recognize the code, it does not display the security icon on the display 37. If a further level of security is deemed necessary, the original VPPR may have a code generator synchronized with the security circuit 32. Then the binary coded cue changes each time it is generated.

Then the user enters PIN data which is directed to the cryptography block 32 for encryption. Thus, information leaving the glass is encrypted.

A hypothesized hacker seeks to bypass the security block 32 to obtain unencrypted PIN data. Assume, arguendo, that he gains control of the microprocessor 31 and uses software of his design to mimic the actions of the original VPPR. He attempts to cue the microprocessor 32 to display the security icon.

Since the software in the payment device is compiled, the prospective hacker needs the original source code to identify and transmit the necessary binary code.

The ersatz VPPR has to generate the valid cue. If the security block 32 does not recognize the code proffered, it will not initiate the display of the security icon. The user recognizes the absence of the security icon and refrains from entering sensitive data (e.g., a PIN). Indeed, the encryption circuit 32 may initiate the disablement of the PDA.

The device 1 may have a separate visible indicator for each type of data that a customer may enter. For example, a first icon may indicate a device 1 secure for PIN entry, while a second different icon may indicate that the device 1 is secure for signatures. In addition or in the alternative, a single visible indicator may indicate that two or more types of data may be entered securely or that any of multiple types of data may be entered securely.

A visible security indicator is not part of the main display 39 of a touchscreen incorporating the touch pad 1 but is a separate display 37 under different control than the main display 39. For example, the main display 39 of a touchscreen is typically under the programmatic control of a processor 31 while the display 37 is under the control of the security circuit 32.

Data entered on and encrypted by the touch pad 1 is made available to external processors by means of a communications link from the control circuit 3A. This may be the “pigtail” of the art.

The class of devices incorporating a touch pad 1 may include point-of-sale (POS) devices, automated teller machines (ATMs), kiosks, mobile phones, keyboards, internet-protocol phones (Voice Over IP or VoIP), laptops and entertainment consoles. Payment terminals, internet appliances and PDAs have already been mentioned.

For merchants, a device incorporating a touch pad 1 helps to reduce the cost of a card-payment transaction. The physical security reduces or eliminates the opportunity for fraud. Touch-pad data—including PINs, passwords and signatures—are encrypted at the point-of-entry to ensure the security of this information and decrease the cost of the transaction.

The invention now being fully described, one of ordinary skill in the art will readily recognize many changes and modifications that can be made thereto without departing from the spirit of the appended claims.

What is claimed is:

1. A data-entry apparatus comprising:
a device for entering data;
a display for displaying information confirming the security of the data-entry apparatus; and
an encryption circuit, communicatively coupled to the data-entry device and the display.

2. The data-entry apparatus of claim 1,
wherein the device for entering data comprises
a touch pad.

3. The apparatus of claim 1, further comprising a second display, and
wherein the first and second displays are physically separate.

4. The apparatus of claim 1, further comprising a second display, and
wherein the first and second displays are under the control of respective first and second controllers that in turn are communicatively coupled to and under the control of the encryption circuit.

5. The apparatus of claim 1, wherein the displayed information comprises
an icon.

6. A method for accepting data on a data-entry apparatus, the method comprising:
refraining from displaying information asserting a data-entry device's ability to securely receive data;
then preparing to encrypt data received on the data-entry device;
then displaying information asserting the data-entry device's ability to securely receive data.
